(19) United States
(12) Patent Application Publication
(10) Pub. No.: US 2020/0326963 A1
(43) Pub. Date: Oct. 15, 2020

(54) System and Method of Provisioning Virtualization Instances with One or More Hardware Attributes

(71) Applicant: Dell Products L.P., Round Rock, TX (US)

(72) Inventors: Abhijeet Bhattacharya, Bangalore (IN); Rajeev Arakkal, Kerala (IN)

(21) Appl. No.: 16/380,083

(22) Filed: Apr. 10, 2019

(51) Int. Cl. G06F 9/455; H04L 9/32; G06F 16/22; H04L 12/24

(52) U.S. Cl. CPC G06F 9/45558; H04L 9/3247; H04L 9/0643; H04L 41/0806; G06F 2009/45562; G06F 16/2228

(57) ABSTRACT

In one or more embodiments, one or more systems, methods, and/or processes may receive a request for a data structure that includes information associated with a target physical information handling system (IHS) that complies with one or more criteria; may query each physical IHS of multiple physical information handling systems (IHSs) for information associated with multiple physical hardware components of the physical IHS; may receive, from at least one physical IHS of the multiple physical IHSs, the data structure that includes the information associated with the target physical IHS that complies with the one or more criteria; may determine that the data structure, from the at least one IHS of the multiple IHSs, includes the information associated with the target physical IHS that complies with the one or more criteria; and may provide, to a network, the data structure and a digital signature associated with the data structure.

### BACKGROUND

### Field of the Disclosure

This disclosure relates generally to information handling systems and more particularly to provisioning virtualization instances with one or more hardware attributes.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

In one or more embodiments, one or more systems, methods, and/or processes may

receive a request for a data structure, wherein the request includes one or more criteria that indicate one or more physical hardware components of a target physical information handling system; may query each physical information handling system of multiple physical information handling systems for information associated with multiple physical hardware components of the physical information handling system; may receive, from at least one physical information handling system of the multiple physical information handling systems, the data structure, which includes information associated with the target physical information handling system that complies with the one or more criteria; may receive, from at least one physical information handling system of the multiple physical information handling systems, the data structure that includes the information associated with the possible physical information handling system that complies with the one or more criteria; may determine that the data structure, from the at least one information handling system of the multiple information handling systems, includes the information associated with the possible physical information handling system that complies with the one or more criteria; may provide, to a network, the data structure and a digital signature associated with the data structure; and may receive a provisioning request for a virtual machine (VM) to be instantiated by the at least one physical information handling system of the multiple physical information handling systems; and may instantiate the VM on the at least one physical information handling system of the multiple physical information handling systems.

In one or more embodiments, receiving the request may include receiving, via the network, the request from a computer system. In one or more embodiments, providing, to the network, the data structure and the digital signature associated with the data structure may include providing, via the network, the data structure and the digital signature associated with the data structure to the computer system. In one or more embodiments, querying each physical information handling system of the multiple physical information handling systems for the information associated with the multiple physical hardware components of the physical information handling system may include querying each baseboard management controller of each physical information handling system of the multiple physical information handling systems for the information associated with the multiple physical hardware components of the physical information handling system. In one or more embodiments, the data structure may include a JavaScript Object Notation (JSON) object. In one or more embodiments, the one or more physical hardware components of the physical information handling system includes at least one physical hardware component that is compliant with a Federal Information Processing Standard (FIPS). In one or more embodiments, the one or more physical hardware components of the physical information handling system may include at least one graphics processing unit.

### BRIEF DESCRIPTION OF THE DRAWINGS

For a more complete understanding of the present disclosure and its features/advantages, reference is now made to the following description, taken in conjunction with the accompanying drawings, which are not drawn to scale, and in which:

FIG. 1 illustrates an example of an information handling system, according to one or more embodiments;

FIG. 2 illustrates an example of a baseboard management controller, according to one or more embodiments;

FIG. 3A illustrates an example of a cloud provider, according to one or more embodiments;

FIG. 3B illustrates another example of a cloud provider, according to one or more embodiments;

FIGS. 4A and 4B illustrate an example of a method of provisioning a virtual machine, according to one or more embodiments; and

FIG. 5 illustrates another example of a method of provisioning a virtual machine, according to one or more embodiments

### DETAILED DESCRIPTION

In the following description, details are set forth by way of example to facilitate discussion of the disclosed subject matter. It should be apparent to a person of ordinary skill in the field, however, that the disclosed embodiments are examples and not exhaustive of all possible embodiments.

As used herein, a reference numeral refers to a class or type of entity, and any letter following such reference numeral refers to a specific instance of a particular entity of that class or type. Thus, for example, a hypothetical entity referenced by ‘12A’ may refer to a particular instance of a particular class/type, and the reference ‘12’ may refer to a collection of instances belonging to that particular class/type or any one instance of that class/type in general.

In one or more embodiments, one or more information handling systems may be virtualized. In one example, an information handling system may be virtualized via a virtual machine (VM). In another example, an information handling system may be virtualized via a container. For instance, a container may be or include an operating system (OS) virtualization instance. In one or more embodiments, infrastructure as a service (IaaS) may be implemented via one or more virtualizations of one or more information handling systems.

In one or more embodiments, underlying hardware of a VM and/or a container may be concealed from a customer (e.g., a user). For example, one or more specifics of a physical information handling system that executes and/or implements one or more of a VM and a container, among others, may not be provided to a customer. In one or more embodiments, a VM instance and/or a container instance may be associated with one or more attributes that may be associated with one or more specifics of a physical information handling system that executes and/or implements the VM instance and/or the container instance. For example, the VM instance and/or the container instance may be associated with one or more requirements of underlying hardware of the physical information handling system. In one instance, the one or more requirements of underlying hardware of the physical information handling system may include a compliance with one or more of a standard, a regulation, and a law, among others. In a second instance, the one or more requirements of underlying hardware of the physical information handling system may include a specific make and/or model of an information handling system. In a third stance, the one or more requirements of underlying hardware of the physical information handling system may include a specific processor of an information handling system. In another stance, the one or more requirements of underlying hardware of the physical information handling system may include a specific physical component of an information handling system.

In one or more embodiments, a customer may provide a request for specific hardware of a physical information handling system that will implement and/or execute a VM and/or a container. For example, an IaaS provider may receive the request. In one or more embodiments, the IaaS provider may query multiple physical information handling systems that may be utilized in providing one or more IaaS instances. For example, querying the multiple physical information handling systems that may be utilized in providing the one or more IaaS instances may include querying a baseboard management controller (BMC) of each physical information handling system of the multiple physical information handling systems. For instance, a BMC of a physical information handling system of the multiple physical information handling systems may store information associated with physical hardware and/or physical components of the physical information handling system.

In one or more embodiments, the IaaS provider may produce a data structure that includes attributes associated with physical information handling systems that comply with the request for specific hardware of the physical information handling system that will implement and/or execute the VM and/or the container. In one example, the IaaS provider may produce a single data structure that includes attributes associated with physical information handling systems that comply with the request for specific hardware of the physical information handling system that will implement and/or execute the VM and/or the container. In a second example, the IaaS provider may produce multiple data structures, where each of the multiple data structures is associated with attributes associated with a physical information handling system that includes attributes that comply with the request for specific hardware of the physical information handling system that will implement and/or execute the VM and/or the container. In another example, a BMC of a physical information handling system may produce a data structure associated with attributes associated with a physical information handling system that includes attributes that comply with the request for specific hardware of the physical information handling system that will implement and/or execute the VM and/or the container.

In one or more embodiments, the data structure may be signed. For example, the data structure may be signed with a private encryption key. For instance, the private encryption key utilized to sign the data structure may be a private encryption key of a BMC of the physical information handling system that includes attributes that comply with the request for specific hardware of the physical information handling system that may implement and/or execute the VM and/or the container. In one or more embodiments, the customer may verify information of the data structure with a vendor associated with the physical information handling system. For example, the customer may verify one or more attributes of the data structure with the vendor associated with the physical information handling system. In one or more embodiments, the customer may provision the physical information handling system associated with the one or more attributes of the data structure. In one or more embodiments, the customer may utilize the physical information handling system associated with the one or more attributes of the data structure to implement, instantiate, and/or execute the VM and/or the container.

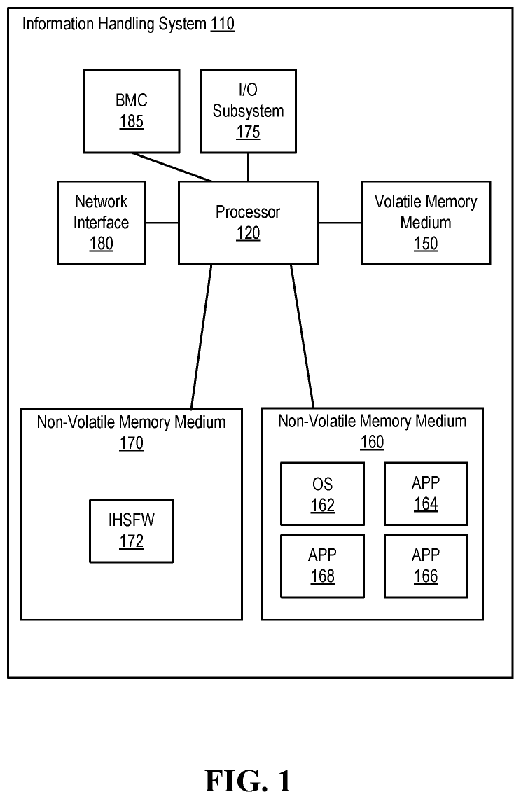

Turning now to FIG. 1, an example of an information handling system is illustrated, according to one or more embodiments. An information handling system (IHS) 110 may include a hardware resource or an aggregate of hardware resources operable to compute, classify, process, transmit, receive, retrieve, originate, switch, store, display, manifest, detect, record, reproduce, handle, and/or utilize various forms of information, intelligence, or data for business, scientific, control, entertainment, or other purposes, according to one or more embodiments. For example, IHS 110 may be or include a physical information handling system. For instance, IHS 110 may be a personal computer, a desktop computer system, a laptop computer system, a server computer system, a mobile device, a tablet computing device, a personal digital assistant (PDA), a consumer electronic device, an electronic music player, an electronic camera, an electronic video player, a wireless access point, a network storage device, or another suitable device and may vary in size, shape, performance, functionality, and price. In one or more embodiments, a portable IHS 110 may include or have a form factor of that of or similar to one or more of a laptop, a notebook, a telephone, a tablet, and a PDA, among others. For example, a portable IHS 110 may be readily carried and/or transported by a user (e.g., a person). In one or more embodiments, components of IHS 110 may include one or more storage devices, one or more communications ports for communicating with external devices as well as various input and output (I/O) devices, such as a keyboard, a mouse, and a video display, among others. In one or more embodiments, IHS 110 may include one or more buses operable to transmit communication between or among two or more hardware components. In one example, a bus of IHS 110 may include one or more of a memory bus, a peripheral bus, and a local bus, among others. In another example, a bus of IHS 110 may include one or more of a Micro Channel Architecture (MCA) bus, an Industry Standard Architecture (ISA) bus, an Enhanced ISA (EISA) bus, a Peripheral Component Interconnect (PCI) bus, HyperTransport (HT) bus, an inter-integrated circuit (I²C) bus, a serial peripheral interface (SPI) bus, a low pin count (LPC) bus, an enhanced serial peripheral interface (eSPI) bus, a universal serial bus (USB), a system management bus (SMBus), and a Video Electronics Standards Association (VESA) local bus, among others.

In one or more embodiments, IHS 110 may include firmware that controls and/or communicates with one or more hard drives, network circuitry, one or more memory devices, one or more I/O devices, and/or one or more other peripheral devices. For example, firmware may include software embedded in an IHS component utilized to perform tasks. In one or more embodiments, firmware may be stored in non-volatile memory, such as storage that does not lose stored data upon loss of power. In one example, firmware associated with an IHS component may be stored in non-volatile memory that is accessible to one or more IHS components. In another example, firmware associated with an IHS component may be stored in non-volatile memory that may be dedicated to and includes part of that component. For instance, an embedded controller may include firmware that may be stored via non-volatile memory that may be dedicated to and includes part of the embedded controller.

As shown, IHS 110 may include a processor 120, a volatile memory medium 150, non-volatile memory media 160 and 170, an I/O subsystem 175, a network interface 180, and a BMC 185. As illustrated, volatile memory medium 150, non-volatile memory media 160 and 170, I/O subsystem 175, network interface 180, and BMC 185 may be communicatively coupled to processor 120.

In one or more embodiments, one or more of volatile memory medium 150, non-volatile memory media 160 and 170, I/O subsystem 175, network interface 180, and BMC 185 may be communicatively coupled to processor 120 via one or more buses, one or more switches, and/or one or more root complexes, among others. In one example, one or more of volatile memory medium 150, non-volatile memory media 160 and 170, I/O subsystem 175, and network interface 180 may be communicatively coupled to processor 120 via one or more PCI-Express (PCIe) root complexes. In another example, one or more of an I/O subsystem 175 and a network interface 180 may be communicatively coupled to processor 120 via one or more PCIe switches.

In one or more embodiments, the term “memory medium” may mean a “storage device”, a “memory”, a “memory device”, a “tangible computer readable storage medium”, and/or a “computer-readable medium”. For example, computer-readable media may include, without limitation, storage media such as a direct access storage device (e.g., a hard disk drive, a floppy disk, etc.), a sequential access storage device (e.g., a tape disk drive), a compact disk (CD), a CD-ROM, a digital versatile disc (DVD), a random access memory (RAM), a read-only memory (ROM), a one-time programmable (OTP) memory, an electrically erasable programmable read-only memory (EEPROM), and/or a flash memory, a solid state drive (SSD), or any combination of the foregoing, among others.

In one or more embodiments, one or more protocols may be utilized in transferring data to and/or from a memory medium. For example, the one or more protocols may include one or more of small computer system interface (SCSI), Serial Attached SCSI (SAS) or another transport that operates with the SCSI protocol, advanced technology attachment (ATA), serial ATA (SATA), a USB interface, an Institute of Electrical and Electronics Engineers (IEEE) 1394 interface, a Thunderbolt interface, an advanced technology attachment packet interface (ATAPI), serial storage architecture (SSA), integrated drive electronics (IDE), or any combination thereof, among others.

Volatile memory medium 150 may include volatile storage such as, for example, RAM, DRAM (dynamic RAM), EDO RAM (extended data out RAM), SRAM (static RAM), etc. One or more of non-volatile memory media 160 and 170 may include nonvolatile storage such as, for example, a read only memory (ROM), a programmable ROM (PROM), an erasable PROM (EPROM), an electrically erasable PROM, NVRAM (non-volatile RAM), ferroelectric RAM (FRAM), a magnetic medium (e.g., a hard drive, a floppy disk, a magnetic tape, etc.), optical storage (e.g., a CD, a DVD, a BLU-RAY disc, etc.), flash memory, a SSD, etc. In one or more embodiments, a memory medium can include one or more volatile storages and/or one or more nonvolatile storages.

In one or more embodiments, network interface 180 may be utilized in communicating with one or more networks and/or one or more other information handling systems. In one example, network interface 180 may enable IHS 110 to communicate via a network utilizing a suitable transmission protocol and/or standard. In a second example, network interface 180 may be coupled to a wired network. In a third example, network interface 180 may be coupled to an optical network. In another example, network interface 180 may be coupled to a wireless network.

In one or more embodiments, network interface 180 may be communicatively coupled via a network to a network storage resource. For example, the network may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, an Internet or another appropriate architecture or system that facilitates the communication of signals, data and/or messages (generally referred to as data). For instance, the network may transmit data utilizing a desired storage and/or communication protocol, including one or more of Fibre Channel, Frame Relay, Asynchronous Transfer Mode (ATM), Internet protocol (IP), other packet-based protocol, Internet SCSI (iSCSI), or any combination thereof, among others.

In one or more embodiments, processor 120 may execute processor instructions in implementing one or more systems, one or more flowcharts, one or more methods, and/or one or more processes described herein. In one example, processor 120 may execute processor instructions from one or more of memory media 150-170 in implementing one or more systems, one or more flowcharts, one or more methods, and/or one or more processes described herein. In another example, processor 120 may execute processor instructions via network interface 180 in implementing one or more systems, one or more flowcharts, one or more methods, and/or one or more processes described herein.

In one or more embodiments, processor 120 may include one or more of a system, a device, and an apparatus operable to interpret and/or execute program instructions and/or process data, among others, and may include one or more of a microprocessor, a microcontroller, a digital signal processor (DSP), an application specific integrated circuit (ASIC), and another digital or analog circuitry configured to interpret and/or execute program instructions and/or process data, among others. In one example, processor 120 may interpret and/or execute program instructions and/or process data stored locally (e.g., via memory media 150-170 and/or another component of IHS 110). In another example, processor 120 may interpret and/or execute program instructions and/or process data stored remotely (e.g., via a network storage resource).

In one or more embodiments, I/O subsystem 175 may represent a variety of communication interfaces, graphics interfaces, video interfaces, user input interfaces, and/or peripheral interfaces, among others. For example, I/O subsystem 175 may include one or more of a touch panel and a display adapter, among others. For instance, a touch panel may include circuitry that enables touch functionality in conjunction with a display that is driven by a display adapter.

As shown, non-volatile memory medium 160 may include an operating system (OS) 162, and applications (APPs) 164-168. In one or more embodiments, one or more of OS 162 and APPs 164-168 may include processor instructions executable by processor 120. In one example, processor 120 may execute processor instructions of one or more of OS 162 and APPs 164-168 via non-volatile memory medium 160. In another example, one or more portions of the processor instructions of the one or more of OS 162 and APPs 164-168 may be transferred to volatile memory medium 150, and processor 120 may execute the one or more portions of the processor instructions of the one or more of OS 162 and APPs 164-168 via volatile memory medium 150.

As illustrated, non-volatile memory medium 170 may include information handling system firmware (IHSFW) 172. In one or more embodiments, IHSFW 172 may include processor instructions executable by processor 120. For example, IHSFW 172 may include one or more structures and/or one or more functionalities of and/or compliant with one or more of a basic input/output system (BIOS), an Extensible Firmware Interface (EFI), a Unified Extensible Firmware Interface (UEFI), and an Advanced Configuration and Power Interface (ACPI), among others. In one instance, processor 120 may execute processor instructions of IHSFW 172 via non-volatile memory medium 170. In another instance, one or more portions of the processor instructions of IHSFW 172 may be transferred to volatile memory medium 150, and processor 120 may execute the one or more portions of the processor instructions of IHSFW 172 via volatile memory medium 150.

In one or more embodiments, BMC 185 may be or include a remote access controller. For example, the remote access controller may be or include a Dell Remote Access Controller (DRAC). In one or more embodiments, a remote access controller may be integrated into IHS 110. For example, the remote access controller may be or include an integrated Dell Remote Access Controller (iDRAC). In one or more embodiments, a remote access controller may include one or more of a processor, and a memory, a network interface, among others. In one or more embodiments, a remote access controller may access one or more busses and/or one or more portions of IHS 110. For example, the remote access controller may include and/or may provide power management, virtual media access, and/or remote console capabilities, among others, which may be available via a web browser and/or a command line interface. For instance, the remote access controller may provide and/or permit an administrator (e.g., a user) one or more abilities to configure and/or maintain an information handling system as if the administrator was at a console of the information handling system and/or had physical access to the information handling system.

In one or more embodiments, a remote access controller may interface with baseboard management controller integrated circuits. In one example, the remote access controller may be based at least on an Intelligent Platform Management Interface (IPMI) standard. For instance, the remote access controller may allow and/or permit utilization of IPMI out-of-band interfaces such as IPMI Over LAN (local area network). In another example, the remote access controller may be based at least on a Redfish standard. In one instance, one or more portions of the remote access controller may be compliant with one or more portions of a Redfish standard. In another instance, one or more portions of the remote access controller may implement one or more portions of a Redfish standard. In one or more embodiments, a remote access controller may include and/or provide one or more internal private networks. For example, the remote access controller may include and/or provide one or more of an Ethernet interface, a front panel USB interface, and a Wi-Fi interface, among others. In one or more embodiments, a remote access controller may be, include, or form at least a portion of a virtual KVM (keyboard, video, and mouse) device. For example, a remote access controller may be, include, or form at least a portion of a KVM over IP (IPKVM) device. For instance, a remote access controller may capture video, keyboard, and/or mouse signals; may convert the signals into packets; and may provide the packets to a remote console application via a network.

In one or more embodiments, BMC 185 may be or include a microcontroller. For example, the microcontroller may be or include an 8051 microcontroller, an ARM Cortex-M (e.g., Cortex-M0, Cortex-M1, Cortex-M3, Cortex-M4, Cortex-M7, etc.) microcontroller, a MSP430 microcontroller, an AVR (e.g., 8-bit AVR, AVR-32, etc.) microcontroller, a PIC microcontroller, a 68HC11 microcontroller, a ColdFire microcontroller, and a Renesas microcontroller, among others. In one or more embodiments, BMC 185 may be or include an application processor. In one example, BMC 185 may be or include an ARM Cortex-A processor. In another example, BMC 185 may be or include an Intel Atom processor. In one or more embodiments, BMC 185 may be or include one or more of a field programmable gate array (FPGA) and an ASIC, among others, configured, coded, and/or encoded with instructions in accordance with at least a portion of one or more of systems, one or more flowcharts, one or more methods, and/or one or more processes described herein.

In one or more embodiments, processor 120 and one or more components of IHS 110 may be included in a system-on-chip (SoC). For example, the SoC may include processor 120 and a platform controller hub (not specifically illustrated).

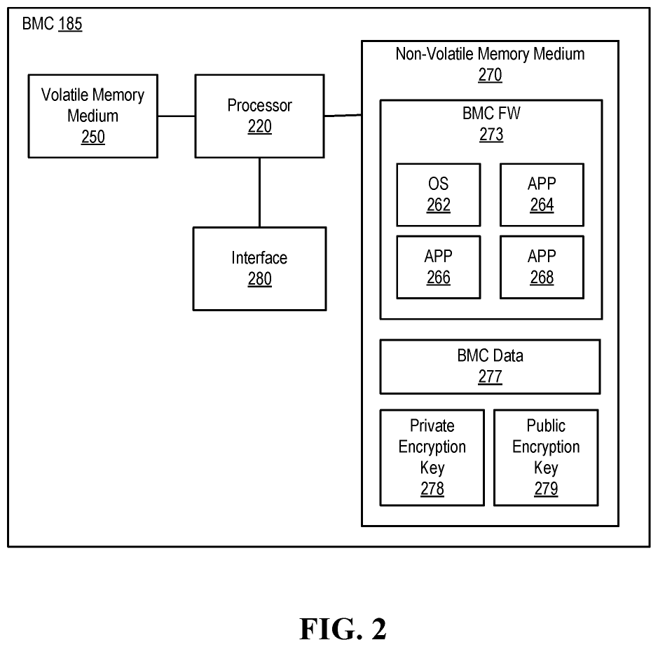

Turning now to FIG. 2, an example of a baseboard management controller is illustrated, according to one or more embodiments. As shown, BMC 185 may include a processor 220, a volatile memory medium 250, a non-volatile memory medium 270, and an interface 280. As illustrated, non-volatile memory medium 270 may include a BMC firmware (FW) 273, which may include an OS 262 and APPs 264-268, and may include BMC data 277. In one example, OS 262 may be or include a real-time operating system (RTOS). In a second example, OS 262 may be or include an Unix-like operating system. For instance, the Unix-like operating system may be or include Linux, FreeBSD, NetBSD, OpenBSD, Minix, Xinu, or Darwin, among others. In another example, OS 262 may be or include a portable operating system interface (POSIX) compliant operating system. As illustrated, non-volatile memory medium 270 may include a private encryption key 278. As shown, non-volatile memory medium 270 may include a public encryption key 279. In one or more embodiments, private encryption key 278 and public encryption key 279 may be asymmetric encryption keys. In one example, data encrypted via private encryption key 278 may be decrypted via public encryption key 279. In another example, data encrypted via public encryption key 279 may be decrypted via private encryption key 278.

In one or more embodiments, interface 280 may include circuitry that enables communicatively coupling to one or more devices. In one example, interface 280 may include circuitry that enables communicatively coupling to one or more buses. For instance, the one or more buses may include one or more buses described herein, among others. In a second example, interface 280 may include circuitry that enables one or more interrupt signals to be received. In one instance, interface 280 may include general purpose input/output (GPIO) circuitry, and the GPIO circuitry may enable one or more interrupt signals to be received and/or provided via at least one interrupt line. In another instance, interface 280 may include GPIO circuitry that may enable BMC 185 to provide and/or receive signals associated with other circuitry (e.g., diagnostic circuitry, etc.). In a third example, interface 280 may include circuitry that enables communicatively coupling to one or more networks. In one instance, interface 280 may include circuitry that enables communicatively coupling to network interface 180. In another example, interface 280 may include a network interface.

In one or more embodiments, one or more of OS 262 and APPs 264-268 may include processor instructions executable by processor 220. In one example, processor 220 may execute processor instructions of one or more of OS 262 and APPs 264-268 via non-volatile memory medium 270. In another example, one or more portions of the processor instructions of the one or more of OS 262 and APPs 264-268 may be transferred to volatile memory medium 250, and processor 220 may execute the one or more portions of the processor instructions of the one or more of OS 262 and APPs 264-268 via volatile memory medium 250. In one or more embodiments, processor 220 may execute instructions in accordance with at least a portion of one or more systems, one or more flowcharts, one or more methods, and/or one or more processes described herein. For example, non-volatile memory medium 270 and/or volatile memory medium 260 may store instructions that may be executable in accordance with at least a portion of one or more systems, flowcharts, one or more methods, and/or one or more processes described herein. In one or more embodiments, processor 220 may execute instructions in accordance with at least a portion of one or more of systems, flowcharts, methods, and/or processes described herein. For example, non-volatile memory medium 270 and/or volatile memory medium 260 may store instructions that may be executable in accordance with at least a portion of one or more of systems, flowcharts, methods, and/or processes described herein. In one or more embodiments, processor 220 may utilize BMC data 277. In one example, processor 220 may utilize BMC data 277 via non-volatile memory medium 270. In another example, one or more portions of BMC data 277 may be transferred to volatile memory medium 250, and processor 220 may utilize BMC data 277 via volatile memory medium 250. As shown, non-volatile memory medium 270 may include a private encryption key 278. As illustrated, non-volatile memory medium 270 may include a public encryption key 279.

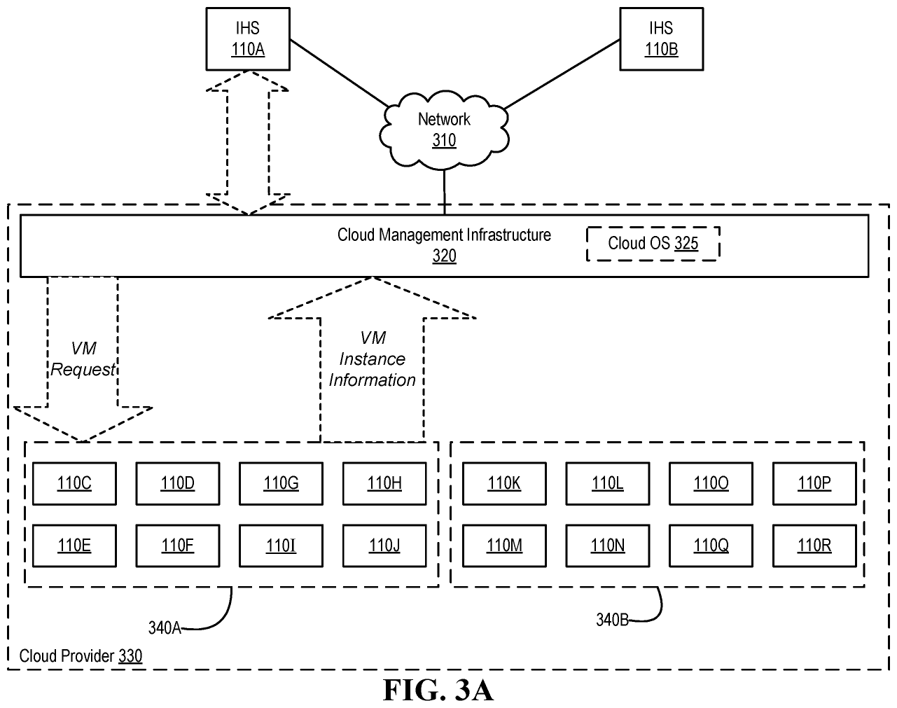

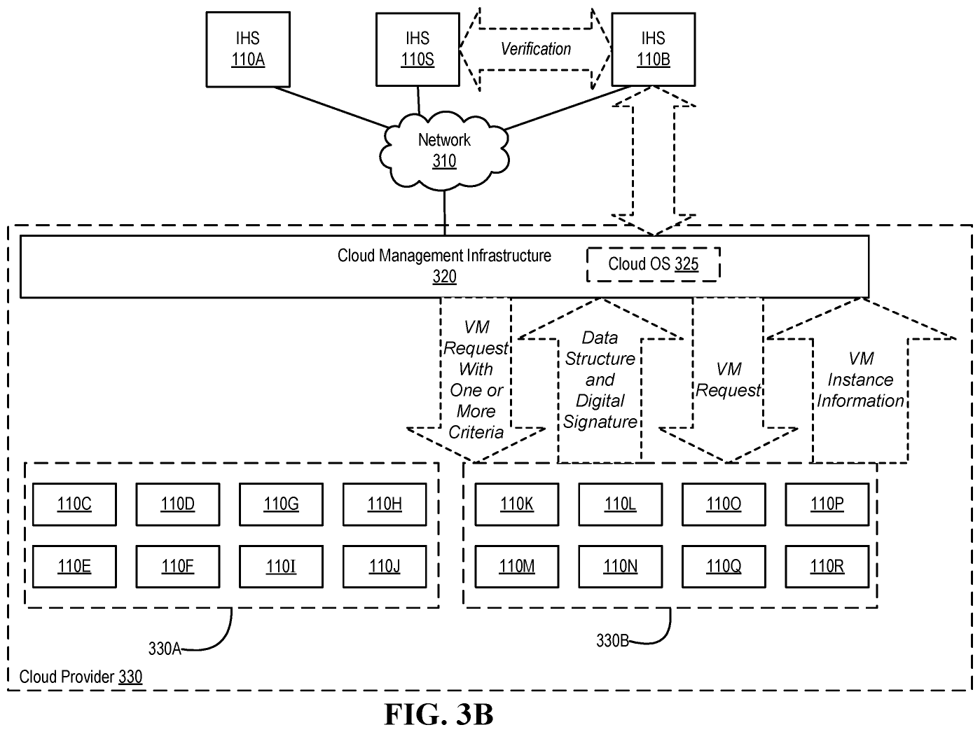

Turning now to FIG. 3A, an example of a cloud provider is illustrated, according to one or more embodiments. As shown, information handling systems (IHSs) 110A and 110B may be coupled to a network 310. As illustrated, a cloud management infrastructure 320 may be coupled to network 310. In one or more embodiments, cloud management infrastructure 320 may include one or more information handling systems. As shown, cloud management infrastructure 320 may include a cloud OS 325. In one or more embodiments, one or more information handling systems of cloud management infrastructure 320 may execute cloud OS 325. In one or more embodiments, one or more information handling systems of cloud management infrastructure 320 may execute at least a portion of cloud OS 325. In one or more embodiments, cloud management infrastructure 320 may be configured, coded, and/or encoded with instructions in accordance with at least a portion of one or more of systems, one or more flowcharts, one or more methods, and/or one or more processes described herein. For example, one or more information handling systems of cloud management infrastructure 320 may be configured, coded, and/or encoded with instructions in accordance with at least a portion of one or more of systems, one or more flowcharts, one or more methods, and/or one or more processes described herein.

In one or more embodiments, network 310 may include a wired network, a wireless network, an optical network, or a combination of the foregoing, among others. In one or more embodiments, network 310 may include and/or be coupled to various types of communications networks. For example, network 310 may include and/or be coupled to a LAN, a WAN, an Internet, a public switched telephone network (PSTN), a cellular telephone network, a satellite telephone network, or a combination of the foregoing, among others. In one or more embodiments, a WAN may include a private WAN, a corporate WAN, a public WAN, or a combination of the foregoing, among others.

As illustrated, a cloud provider 330 may include IHSs 110C-110R and cloud management infrastructure 320. In one or more embodiments, cloud provider 330 may be or include an IaaS provider. In one or more embodiments, one or more of IHSs 110C-110R may be coupled to network 310. For example, one or more of IHSs 110C-110R may be coupled to network 310 via cloud management infrastructure 320. For instance, cloud management infrastructure 320 may include one or more network routers, one or more network switches, and/or one or more networks, among others. In one or more embodiments, one or more IHSs may be included in a server grouping. In one example, IHSs 110C-110J may be included in a server grouping 340A. In another example, IHSs 110K-110R may be included in a server grouping 340B. In one or more embodiments, a server grouping may include IHSs that may not have cataloged hardware components. For example, server grouping 340A may include IHSs that may not have cataloged hardware components. In one or more embodiments, a server grouping may include IHSs that may include cataloged hardware components. For example, server grouping 340B may include IHSs that may include cataloged hardware components. For instance, each IHS of one or more of IHS 110K-110R may respond to one or more queries for hardware components that the IHS may include.

As shown, IHS 110A may communicate with cloud management infrastructure 320. For example, IHS 110A may communicate with cloud management infrastructure 320 via network 310. In one or more embodiments, a customer may operate IHS 110A. In one or more embodiments, IHS 110A may provide a request for a VM to cloud management infrastructure 320. For example, cloud management infrastructure 320 may provide a VM request (e.g., a request for a VM to be allocated and/or instantiated) to an IHS of IHSs 110C-110J. For instance, the IHS of one or more of IHSs 110C-110J may provide a VM instance to cloud management infrastructure 320. In one or more embodiments, a VM instance may be allocated and/or instantiated on the IHS of one or more of IHSs 110C-110J. For example, information associated with the VM instance may be provided to cloud management infrastructure 320. For instance, providing the VM instance to cloud management infrastructure 320 may include providing the information associated with the VM instance to cloud management infrastructure 320. In one or more embodiments, cloud management infrastructure 320 may provide the information associated with the VM instance to IHS 110A. For example, IHS 110A may utilize the information associated with the VM instance to interact with the VM instance. For instance, IHS 110A may utilize the information associated with the VM instance to provide a workload to the VM instance.

Turning now to FIG. 3B, another example of a cloud provider is illustrated, according to one or more embodiments. As shown, IHS 110B may communicate with cloud management infrastructure 320. For example, IHS 110B may communicate with cloud management infrastructure 320 via network 310. In one or more embodiments, a customer may operate IHS 110B. In one or more embodiments, IHS 110B may provide a request for a VM to cloud management infrastructure 320.

In one or more embodiments, cloud management infrastructure 320 may receive a request, which includes one or more criteria that indicates one or more physical hardware components of a possible physical information handling system, for a data structure that includes information associated with the possible physical information handling system that complies with the one or more criteria. For example, cloud management infrastructure 320 may query each of IHSs 110K-110R for information associated with multiple physical hardware components. For instance, querying each of IHSs 110K-110R for information associated with multiple physical hardware components may include querying each BMC 185 of each of IHSs 110K-110R for information associated with multiple physical hardware components. In one or more embodiments, a BMC 185 of an IHS 110 may include information associated with physical hardware components of IHS 110. In one example, BMC 185 of IHS 110 may store data, via one or more of memory media 250, 270, 150, 160, and/or 170, associated with physical hardware components of IHS 110. In another example, BMC 185 of IHS 110 may store data, via one or more of memory media 250, 270, 150, 160, and/or 170, associated with a make and/or a model of IHS 110.

In one or more embodiments, each IHS of IHSs 110K-110R may create a data structure that includes information associated with physical hardware components of the IHS. For example, each BMC 185 of each IHS of IHSs 110K-110R may create a data structure that includes information associated with physical hardware components of the IHS. In one instance, the data structure may be or include a JavaScript Object Notation (JSON) object. In second instance, the data structure may be or include an eXtensible Markup Language (XML) object. In another example, the data structure may be or include a YAML (YAML Ain't Markup Language) object. For instance, a YAML object may be or include a YAML file. In one or more embodiments, not all of IHSs 110K-110R may respond to a query. For example, if it is determined that an IHS of IHSs 110K-110R does not meet the one or more criteria that indicates one or more physical hardware components of a physical information handling system, the IHS may not respond to the query.

In one or more embodiments, an IHS of IHSs 110K-110R may produce a digital signature associated with a data structure. For example, a BMC 185 of the IHS of IHSs 110K-110R may produce a digital signature associated with a data structure. For instance, BMC 185 of the IHS may produce the digital signature associated with the data structure based at least on salt data, a hash value (e.g., a hash value of a one-way hash function), and private encryption key 278. In one example, the salt data may include a random number. In a second example, the salt data may include a pseudo-random number. In another example, the salt data may include a nonce (e.g., an arbitrary number that may be used once). In one or more embodiments, BMC 185 may determine a hash value of a combination of the salt data and the data structure. For example, BMC 185 may utilize a one-way hash function to determine the hash value of the combination of the salt data and the data structure. In one or more embodiments, BMC 185 may encrypt the hash value. For example, BMC 185 may utilize private encryption key 278 to encrypt the hash value. For instance, BMC 185 may produce a digital signature of the data structure via encrypting, via private encryption key 278, the hash value.

In one or more embodiments, a one-way hash function may be considered collision free. For example, the one-way hash function may be injective or one-to-one. For instance, h(z₁) and h(z₂) may produce different values, where z₁ and z₂ are different. In one or more embodiments, a one-way hash function may be considered a cryptographic checksum, a message digest, a digital fingerprint, a message integrity check, a contraction function, a compression function, and/or a manipulation detection code, among others. Examples of one-way hash functions may include one or more of an Abreast Davies-Meyer, a Davies-Meyer, a message digest (MD) 2, a MD 4, a MD 5, a RIPE-MD, a GOST Hash, a N-HASH, a HAVAL, a SHA (secure hash algorithm) (e.g., SHA-1, SHA-2, SHA-3, SHA-256, etc.), and a SNEFRU, among others. In one or more embodiments, a one-way hash function may be a composite function of two or more one-way hash functions. For example, a function h₁ may include a MD 5 one-way hash function h₂, a SHA one-way hash function h₃, and a MD 5 one-way hash function h₄, such that h₁=h₂(h₃(h₄(z))). For instance, a one-way hash function that is a composite function of two or more one-way hash functions may be considered to be and/or said to be strengthened.

In one or more embodiments, a data structure that includes attributes associated a physical IHS that comply with the one or more criteria may be provided to cloud management infrastructure 320. For example, BMC 185 of the IHS may provide the data structure and the digital signature of the data structure to cloud management infrastructure 320. In one or more embodiments, cloud management infrastructure 320 may provide the data structure and the digital signature of the data structure to IHS 110B. In one or more embodiments, IHS 110B may verify the data structure. In one example, IHS 110B may verify information of the data structure with a digital signature associated with the data structure. In another example, IHS 110B may verify information of the data structure with an IHS 1105.

In one or more embodiments, IHS 1105 may be associated with a manufacturer of an IHS associated with the data structure. For example, IHS 1105 may provide a response to IHS 110B. For instance, the response may indicate if the information of the data structure verified. In one or more embodiments, verifying the information of the data structure may include determining if the information of the data structure matches one or more records associated with the IHS that is associated with the data structure. For example, IHS 1105 may store and/or access the one or more records. In one instance, IHS 1105 may access the one or more records via a storage device. In another instance, IHS 1105 may access the one or more records via a network.

In one or more embodiments, IHS 110B may provide a provisioning request to cloud management infrastructure 320. For example, cloud management infrastructure 320 may receive the provisioning request from IHS 110B. In one or more embodiments, the provisioning request may be encrypted via a public encryption key. For example, the public encryption key may be or include public encryption key 279 of the IHS associated with the data structure. In one or more embodiments, a hypervisor may validate the public encryption key with BMC 185 of the IHS associated with the data structure. In one or more embodiments, IHS 110B may provide a VM image to cloud management infrastructure 320. For example, cloud management infrastructure 320 may receive the VM image from IHS 110B.

In one or more embodiments, the VM image may be encrypted. For example, the VM image may be encrypted with public encryption key 279 of the IHS associated with the data structure. In one or more embodiments, an encrypted VM image may be decrypted. In one example, a hypervisor may decrypt the encrypted VM image. For instance, the hypervisor may decrypt the encrypted VM image to produce a VM image. In another example, BMC 185 may decrypt the encrypted VM image. For instance, BMC 185 may decrypt the encrypted VM image to produce a VM image. In one or more embodiments, BMC 185 may provide the VM image to a hypervisor. In one or more embodiments, the VM image may be executed and/or run on a physical information handling system. For example, the physical information handling system may be an IHS of IHSs 110K-110R. In one or more embodiments, the provisioning request may specify the physical information handling system. For example, the provisioning request may specify the physical information handling system via an identification. For instance, the identification may include one or more of a string of characters, an information handling system service tag, an Internet protocol (IP) address, a media access control (MAC) address, a universally unique identifier (UUID), and a globally unique identifier (GUID), among others.

In one or more embodiments, the VM image may be instantiated as a VM on the physical information handling system. In one or more embodiments, the physical information handling system may provide identification information to cloud management infrastructure 320. For example, the identification information may be utilized by IHS 110B to communicate with the VM. For instance, the identification information may include an IP address, a MAC address, a UUID, and a GUID, among others, associated with the VM. In one or more embodiments, cloud management infrastructure 320 may provide the identification information to IHS 110B. In one or more embodiments, IHS 110B may provide a workload to the VM. For example, the VM may receive the workload.

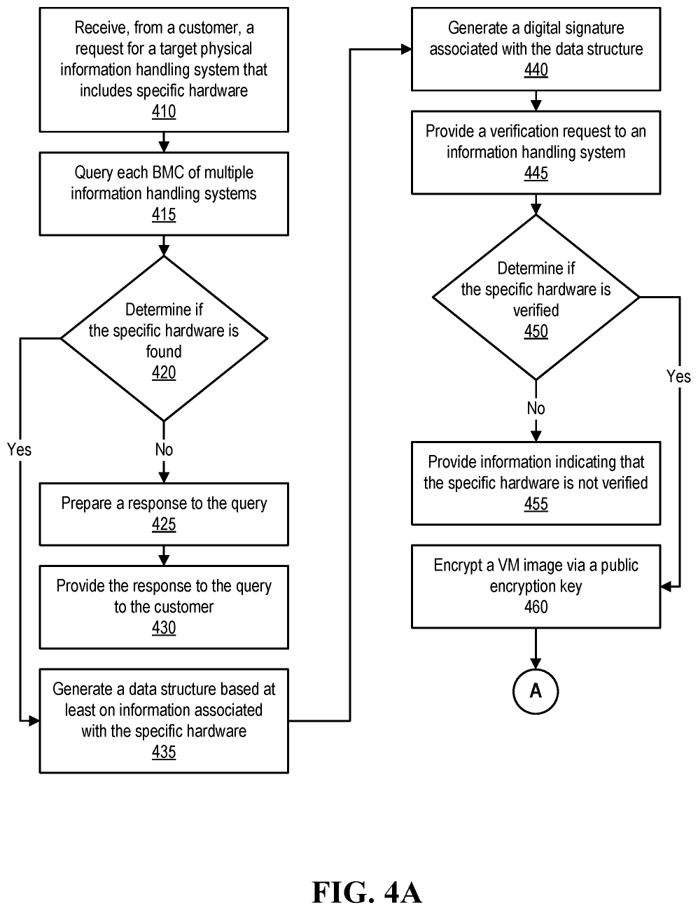

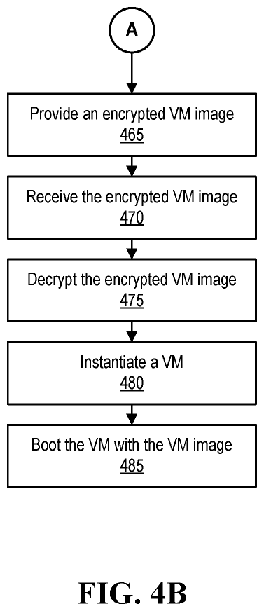

Turning now to FIGS. 4A and 4B, an example of a method of provisioning a virtual machine is illustrated, according to one or more embodiments. At 410, a request for a target physical information handling system that includes specific hardware may be received from a customer. For example, receiving a request for a target physical information handling system that includes specific hardware may include receiving the request for the target physical information handling system that includes specific hardware from an information handling system operated by the customer. For instance, the request may be received from IHS 110B. In one or more embodiments, the request may include one or more criteria that indicate one or more physical hardware components of the target physical information handling system. In one or more embodiments, the request may be received via a network. For example, the network may be or include network 310.

At 415, each BMC of multiple information handling systems may be queried. For example, cloud management infrastructure 320 may query each BMC 185 of IHSs 110K-110R. In one or more embodiments, a BMC 185 may store an inventory of physical hardware components of its respective IHS 110. For example, BMC 185 may store the inventory of physical hardware components of its respective IHS 110 via one or more of memory media 150, 160, 170, 250, and 270, among others. In one or more embodiments, a BMC 185 may determine an inventory of physical hardware components of its respective IHS 110. For example, a BMC 185 may determine an inventory of physical hardware components of its respective IHS 110 in response to receiving a query from cloud management infrastructure 320. For instance, a BMC 185 may determine an inventory of physical hardware components of its respective IHS 110 in response to receiving a query from an information handling system of cloud management infrastructure 320.

At 420, it may be determine if the specific hardware is found. In one example, cloud management infrastructure 320 may determine if the specific hardware is found. For instance, an information handling system of cloud management infrastructure 320 may determine if the specific hardware is found. In another example, a BMC 185 of its respective IHS 110 may determine if the specific hardware is found.

If the specific hardware is not found, a response to the query may be prepared, at 425. In one example, cloud management infrastructure 320 may prepare a response to the query. For instance, an information handling system of cloud management infrastructure 320 may prepare a response to the query. In another example, a BMC 185 of a respective IHS 110 may prepare a response to the query. In one or more embodiments, the response to the query may include information that indicates that the specific hardware was not found.

At 430, the response to the query may be provided to the customer. For example, cloud management infrastructure 320 may provide the response to the query to the customer. For instance, an information handling system of cloud management infrastructure 320 may provide the response to the query to the customer. In one or more embodiments, providing the response to the query to the customer may include providing the response to the query to an information handling system of the customer. For example, the response to the query may be provided to IHS 110B of the customer. For instance, the response to the query may be provided to IHS 110B via network 310.

If the specific hardware is found, a data structure based at least on information associated with the specific hardware may be generated, at 435. In one example, cloud management infrastructure 320 may generate a data structure based at least on information associated with the specific hardware. For instance, an information handling system of cloud management infrastructure 320 may generate a data structure based at least on information associated with the specific hardware. In another example, a BMC 185 of its respective IHS 110 may generate a data structure based at least on information associated with the specific hardware.

In one or more embodiments, the data structure based at least on information associated with the specific hardware may be or include an object (e.g., a data object). In one example, the data structure based at least on information associated with the specific hardware may be or include a JSON object. In a second example, the data structure based at least on information associated with the specific hardware may be or include a XML object. In another, the data structure based at least on information associated with the specific hardware may be or include a YAML object.

At 440, a digital signature associated with the data structure may be generated. For example, the digital signature associated with the data structure may be based at least on one or more of a hash value of data structure, salt data, and a private encryption key. For instance, a BMC 185 of its respective IHS 110 may generate the digital signature associated with the data structure, based at least on one or more of a hash value of data structure, salt data, and private encryption key 278. In one or more embodiments, BMC 185 may utilize private encryption key 278 to encrypt a hash value of a combination of salt data and the data structure.

In one or more embodiments, another IHS (e.g., IHS 110B) may utilize the digital signature associated with the data structure to authenticate the data structure and/or to authenticate information of the data structure. In one or more embodiments, BMC 185 may provide the digital signature and/or the data structure to cloud management infrastructure 320. For example, BMC 185 may provide the digital the data structure to an information handling system of cloud management infrastructure 320. In one or more embodiments, cloud management infrastructure 320 may receive the digital signature and/or the data structure from BMC 185. For example, an information handling system of cloud management infrastructure 320 may receive the digital signature and/or the data structure from BMC 185.

At 445, a verification request may be provided to an information handling system. For example, a verification request may be provided to IHS 1105. For instance, IHS 1105 may receive the verification request. In one or more embodiments, the verification request may provided and/or received via network 310.

In one or more embodiments, IHS 1105 may be owned and/or operated by a manufacture of information handling systems. For example, the manufacture may be or include a manufacturer of the target physical information handling system. In one or more embodiments, the verification request may include the data structure and/or an identification of the target information handling system. For example, the verification request may include the data structure and/or an identification of an information handling system associated with the data structure. In one or more embodiments, IHS 1105 may store and/or may have access to one or more records associated with one or more of IHSs 110K-110R. For example, the one or more records associated with one or more of IHSs 110K-110R may include information associated with one or more physical hardware components of respective one or more IHSs 110K-110R.

In one or more embodiments, IHS 1105 may determine if information of the data structure is true. If the information of the data structure is true, IHS 1105 may provide a response indicating that the information of the data structure is true. If the information of the data structure is not true, IHS 1105 may provide a response indicating that the information of the data structure is not true. In one or more embodiments, IHS 110B may receive the response from IHS 1105. For example, IHS 110B may receive the response from IHS 1105 via network 310.

At 450, it may be determined if the specific hardware is verified. For example, IHS 110B may determine if the specific hardware is verified. In one or more embodiments, IHS 110B may determine if the specific hardware is verified based at least on the response from IHS 1105. In one example, the response from IHS 1105 may indicate if the information of the data structure is true. In another example, the response from IHS 1105 may indicate if the information of the data structure is not true.

If the specific hardware is not verified, information indicating that the specific hardware is not verified may be provided, at 455. For example, IHS 110B may provide information indicating that the specific hardware is not verified. In one instance, IHS 110B may provide the information indicating that the specific hardware is not verified via a display associated with IHS 110B. In a second instance, IHS 110B may provide the information indicating that the specific hardware is not verified via a log file. In another instance, IHS 110B may provide the information indicating that the specific hardware is not verified via network 310.

If the specific hardware is verified, a VM image may be encrypted via a public encryption key, at 460. For example, a VM image may be encrypted via public encryption key 279. For instance, IHS 110B may encrypt a VM image via public encryption key 279. In one or more embodiments, encrypting a VM image via a public encryption key may produce an encrypted VM image.

At 465, an encrypted VM image may be provided. For example, IHS 110B may provide an encrypted VM image. In one instance, IHS 110B may provide the encrypted VM image to an IHS of IHSs 110K-110R associated with the data structure. In another instance, IHS 110B may provide the encrypted VM image to an IHS of IHSs 110K-110R associated with public encryption key 279. In one or more embodiments, providing the encrypted VM image to the IHS of IHSs 110K-110R may include providing the encrypted VM image to the IHS of IHSs 110K-110R via network 310. In one or more embodiments, IHS 110B may provide the encrypted VM image to cloud management infrastructure 320 via network 310. For example, IHS 110B may provide the encrypted VM image to an information handling system of cloud management infrastructure 320 via network 310.

At 470, the encrypted VM image may be received. For example, the IHS of IHSs 110K-110R associated with the data structure may receive the encrypted VM image. At 475, the encrypted VM image may be decrypted. For example, the encrypted VM image may be decrypted via a private encryption key associated with the public encrypting key that was utilized to generate the encrypted VM image. For instance, the private encryption key may be or include private encryption key 278. In one or more embodiments, BMC 185, of the IHS of IHSs 110K-110R associated with the data structure, may decrypt the encrypted VM image to generate the VM image. In one or more embodiments, a hypervisor may utilize private encryption key 278 to decrypt the encrypted VM image to generate the VM image.

At 480, a VM may be instantiated. For example, a VM may be instantiated on the IHS of IHSs 110K-110R associated with the data structure. For instance, the hypervisor may instantiate a VM on the IHS of IHSs 110K-110R associated with the data structure. At 485, the VM may be booted with the VM image. For example, the hypervisor may boot the VM image.

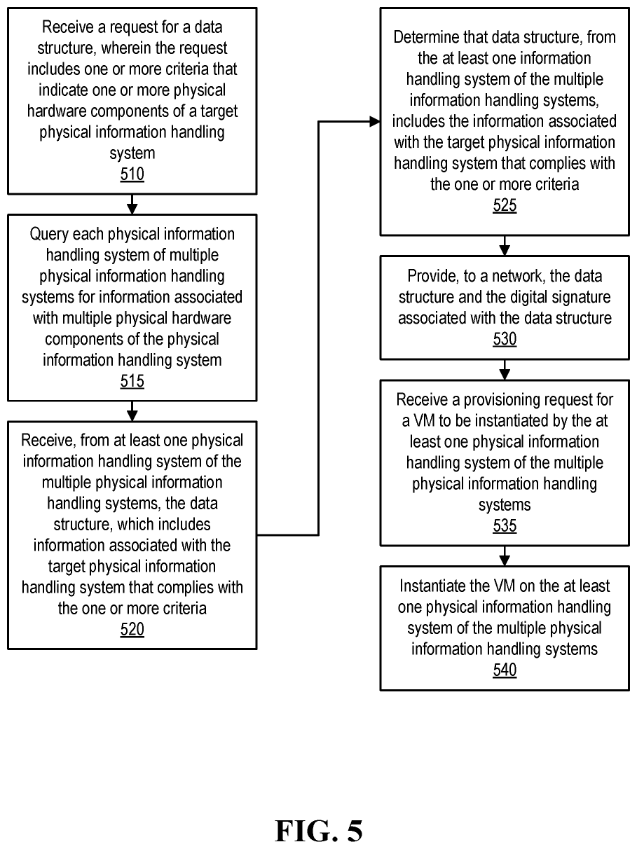

Turning now to FIG. 5, another example of a method of provisioning a virtual machine is illustrated, according to one or more embodiments. At 510, a request for a data structure may be received, where the request includes. For example, cloud management infrastructure 320 may receive a request for a data structure, where the request includes one or more criteria that indicate one or more physical hardware components of a target physical information handling system. For instance, an information handling system of cloud management infrastructure 320 may receive a request for a data structure, where the request includes one or more criteria that indicate one or more physical hardware components of a target physical information handling system. In one or more embodiments, the request may be received via network 310. For example, IHS 110B may provide the request via network 310. For instance, the request may be received, via network 310, from IHS 110B.

In one or more embodiments, the one or more physical hardware components of the physical information handling system may include at least one graphics processing unit (GPU). In one or more embodiments, the one or more physical hardware components of the physical information handling system may include at least one SSD. In one or more embodiments, the one or more physical hardware components of the physical information handling system may include at least one physical hardware component that is compliant with a Federal Information Processing Standard (FIPS). In one or more embodiments, a FIPS specification may be or include a modified version of a standard. For example, a FIPS specification may be or include a modified version of one or more of an American National Standards Institute (ANSI) standard, an Institute of Electrical and Electronics Engineers (IEEE) standard, and an the International Organization for Standardization (ISO) standard, among others.

In one or more embodiments, the one or more criteria may indicate a processor of a manufacturer. For example, a string of characters may indicate a processor of a manufacturer. In one instance, a manufacturer may include Intel. In a second instance, a manufacturer may include Advanced Micro Devices (AMD). In a third instance, a manufacturer may include Samsung. In a fourth instance, a manufacturer may include Oracle. In a fifth instance, a manufacturer may include IBM. In another instance, a manufacturer may include Qualcomm. In one or more embodiments, the one or more criteria may indicate a manufacturer of the target physical information handling system. For example, a string of characters may indicate a manufacturer. In one instance, a manufacturer may include Dell. In a second instance, a manufacturer may include IBM. In a third instance, a manufacturer may include Samsung. In fourth instance, a manufacturer may include Oracle. In another instance, a manufacturer may include HP. In one or more embodiments, the one or more criteria may indicate a model of the target physical information handling system. For example, a string of characters may indicate the model of the target physical information handling system. In one or more embodiments, the one or more criteria may indicate a minimum trusted platform module (TPM) level.

At 515, each physical information handling system of multiple physical information handling systems may be queried for information associated with multiple physical hardware components of the physical information handling system. For example, cloud management infrastructure 320 may query each physical information handling system of multiple physical information handling systems for information associated with multiple physical hardware components of the physical information handling system. For instance, an information handling system of cloud management infrastructure 320 may query each physical information handling system of multiple physical information handling systems for information associated with multiple physical hardware components of the physical information handling system. In one or more embodiments, querying each physical information handling system of multiple physical information handling systems for information associated with multiple physical hardware components of the physical information handling system may include querying each baseboard management controller of each physical information handling system of multiple physical information handling systems for information associated with multiple physical hardware components of the physical information handling system.

At 520, the data structure, which includes information associated with the target physical information handling system that complies with the one or more criteria may be received from at least one physical information handling system of the multiple physical information handling systems. For example, cloud management infrastructure 320 may receive, from at least one physical information handling system of the multiple physical information handling systems, the data structure, which includes information associated with the target physical information handling system that complies with the one or more criteria. For instance, an information handling system of cloud management infrastructure 320 may receive, from at least one physical information handling system of the multiple physical information handling systems, the data structure, which includes information associated with the target physical information handling system that complies with the one or more criteria.

In one or more embodiments, a BMC of the at least one physical information handling system of the multiple physical information handling systems may produce the data structure that includes the information associated with the target physical information handling system that complies with the one or more criteria. In one or more embodiments, the BMC of the at least one physical information handling system of the multiple physical information handling systems may produce a digital signature of and/or associated with the data structure. For example, the digital signature of and/or associated with the data structure may be based at least on one or more of a hash value of data structure, salt data, and a private encryption key of the BMC. In one or more embodiments, another IHS may utilize the digital signature of and/or associated with the data structure to authenticate the data structure and/or to authenticate information of the data structure. In one or more embodiments, the BMC may provide the digital signature and/or the data structure to cloud management infrastructure 320. For example, the BMC may provide the digital signature and/or the data structure to an information handling system of cloud management infrastructure 320. In one or more embodiments, cloud management infrastructure 320 may receive the digital signature and/or the data structure from the BMC. For example, an information handling system of cloud management infrastructure 320 may receive the digital signature and/or the data structure from the BMC.

At 525, it may be determined that the data structure, from the at least one information handling system of the multiple information handling systems, includes the information associated with the target physical information handling system that complies with the one or more criteria. For example, cloud management infrastructure 320 may determine that the data structure, from the at least one information handling system of the multiple information handling systems, includes the information associated with the target physical information handling system that complies with the one or more criteria. For instance, an information handling system of cloud management infrastructure 320 may determine that the data structure, from the at least one information handling system of the multiple information handling systems, includes the information associated with the target physical information handling system that complies with the one or more criteria.

At 530, the data structure and the digital signature associated with the data structure may be provided to a network. For example, cloud management infrastructure 320 may provide, to network 310, the data structure and the digital signature associated with the data structure. For instance, an information handling system of cloud management infrastructure 320 may provide, to network 310, the data structure and the digital signature associated with the data structure. In one or more embodiments, providing, to a network, the data structure and the digital signature associated with the data structure may include providing the data structure and the digital signature associated with the data structure to a computer system via the network. For example, cloud management infrastructure 320 may provide, to IHS 110B, the data structure and the digital signature associated with the data structure via network 310. For instance, an information handling system of cloud management infrastructure 320 may provide, to IHS 110B, the data structure and the digital signature associated with the data structure via network 310.

At 535, a provisioning request for a VM, to be instantiated by the at least one physical information handling system of the multiple physical information handling systems, may be received. For example, cloud management infrastructure 320 may receive a provisioning request for a VM to be instantiated by the at least one physical information handling system of the multiple physical information handling systems. For instance, an information handling system of cloud management infrastructure 320 may receive a provisioning request for a VM to be instantiated by the at least one physical information handling system of the multiple physical information handling systems.

At 540, the VM may be instantiated on the at least one physical information handling system of the multiple physical information handling systems. For example, cloud management infrastructure 320 may instantiate the VM on the at least one physical information handling system of the multiple physical information handling systems. For instance, an information handling system of cloud management infrastructure 320 may instantiate the VM on the at least one physical information handling system of the multiple physical information handling systems. In one or more embodiments, a hypervisor of the at least one physical information handling system of the multiple physical information handling systems may instantiate the VM on the at least one physical information handling system of the multiple physical information handling systems.

Although the examples of one or more methods, one or more processes, and/or one or more systems recite a VM, a container may be utilized in place of the VM, according to one or more embodiments. For example, the term “container” may be utilized in place of the term “VM”. In one or more embodiments, an OS may instantiate a container. For example, rather than a hypervisor instantiating a VM, an OS may instantiate a container. In one or more embodiments, a container may be in instantiated via an OS that is executing natively on an IHS. In one or more embodiments, a container may be in instantiated via an OS that is executing on a VM.

In one or more embodiments, one or more of the method and/or process elements and/or one or more portions of a method and/or a process element may be performed in varying orders, may be repeated, or may be omitted. Furthermore, additional, supplementary, and/or duplicated method and/or process elements may be implemented, instantiated, and/or performed as desired, according to one or more embodiments. Moreover, one or more of system elements may be omitted and/or additional system elements may be added as desired, according to one or more embodiments.

In one or more embodiments, a memory medium may be and/or may include an article of manufacture. For example, the article of manufacture may include and/or may be a software product and/or a program product. For instance, the memory medium may be coded and/or encoded with processor-executable instructions in accordance with one or more flowcharts, one or more systems, one or more methods, and/or one or more processes described herein to produce the article of manufacture.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. An information handling system, comprising:
at least one processor; and
a memory medium, coupled to the at least one processor, that stores instructions executable by the at least one processor, which when executed by the at least one processor, cause the information handling system to:
receive a request for a data structure, wherein the request includes one or more criteria that indicate one or more physical hardware components of a target physical information handling system;
query each physical information handling system of a plurality of physical information handling systems for information associated with a plurality of physical hardware components of the physical information handling system;
receive, from at least one physical information handling system of the plurality of physical information handling systems, the data structure, which includes information associated with the target physical information handling system that complies with the one or more criteria;
receive, from the at least one physical information handling system of the plurality of physical information handling systems, a digital signature associated with the data structure;
determine that the data structure, from the at least one information handling system of the plurality of information handling systems, includes the information associated with the target physical information handling system that complies with the one or more criteria;
provide, to a network, the data structure and the digital signature associated with the data structure;
receive a provisioning request for a virtual machine (VM) to be instantiated by the at least one physical information handling system of the plurality of physical information handling systems; and
instantiate the VM on the at least one physical information handling system of the plurality of physical information handling systems.

2. The information handling system of claim 1,
wherein, to receive the request, the instructions further cause the information handling system to receive, via the network, the request from a computer system; and
wherein, to provide the data structure and the digital signature associated with the data structure, the instructions further cause the information handling system to provide, via the network, the data structure and the digital signature associated with the data structure to the computer system.

3. The information handling system of claim 1, wherein the data structure includes a JavaScript Object Notation (JSON) object.

4. The information handling system of claim 1, wherein the one or more physical hardware components of the possible physical information handling system includes at least one physical hardware component that is compliant with a Federal Information Processing Standard (FIPS).

5. The information handling system of claim 1, wherein the one or more physical hardware components of the possible physical information handling system includes at least one graphics processing unit.

6. The information handling system of claim 1, wherein, to query each physical information handling system of the plurality of physical information handling systems for the information associated with the plurality of physical hardware components of the physical information handling system, the instructions further cause the information handling system to query each baseboard management controller of each physical information handling system of the plurality of physical information handling systems for the information associated with the plurality of physical hardware components of the physical information handling system.

7. The information handling system of claim 1, wherein the one or more criteria further indicates a processor of a manufacturer.

8. A method, comprising:
receiving a request for a data structure, wherein the request includes one or more criteria that indicate one or more physical hardware components of a target physical information handling system;
querying each physical information handling system of a plurality of physical information handling systems for information associated with a plurality of physical hardware components of the physical information handling system;
receiving, from at least one physical information handling system of the plurality of physical information handling systems, the data structure, which includes information associated with the target physical information handling system that complies with the one or more criteria;
receiving, from the at least one physical information handling system of the plurality of physical information handling systems, a digital signature associated with the data structure;
determining that the data structure, from the at least one information handling system of the plurality of information handling systems, includes the information associated with the target physical information handling system that complies with the one or more criteria;
providing, to a network, the data structure and the digital signature associated with the data structure;
receiving a provisioning request for a virtual machine (VM) to be instantiated by the at least one physical information handling system of the plurality of physical information handling systems; and
instantiating the VM on the at least one physical information handling system of the plurality of physical information handling systems.

9. The method of claim 8,
wherein the receiving the request includes receiving, via the network, the request from a computer system; and
wherein the providing, to the network, the data structure and the digital signature associated with the data structure includes providing, via the network, the data structure and the digital signature associated with the data structure to the computer system.

10. The method of claim 8, wherein the data structure includes a JavaScript Object Notation (JSON) object.

11. The method of claim 8, wherein the one or more physical hardware components of the possible physical information handling system includes at least one physical hardware component that is compliant with a Federal Information Processing Standard (FIPS).

12. The method of claim 8, wherein the one or more physical hardware components of the possible physical information handling system includes at least one graphics processing unit.

13. The method of claim 8, wherein the querying each physical information handling system of the plurality of physical information handling systems for information associated with the plurality of physical hardware components of the physical information handling system includes querying each baseboard management controller of each physical information handling system of the plurality of physical information handling systems for the information associated with the plurality of physical hardware components of the physical information handling system.

14. The method of claim 8, wherein the one or more criteria further indicates a processor of a manufacturer.

15. A computer-readable non-transitory memory medium that includes instructions that, when executed by at least one processor of an information handling system, cause the information handling system to:
receive a request for a data structure, wherein the request includes one or more criteria that indicate one or more physical hardware components of a target physical information handling system;
query each physical information handling system of a plurality of physical information handling systems for information associated with a plurality of physical hardware components of the physical information handling system;
receive, from at least one physical information handling system of the plurality of physical information handling systems, the data structure, which includes information associated with the target physical information handling system that complies with the one or more criteria;
receive, from the at least one physical information handling system of the plurality of physical information handling systems, a digital signature associated with the data structure;
determine that the data structure, from the at least one information handling system of the plurality of information handling systems, includes the information associated with the target physical information handling system that complies with the one or more criteria;
provide, to a network, the data structure and the digital signature associated with the data structure;
receive a provisioning request for a virtual machine (VM) to be instantiated by the at least one physical information handling system of the plurality of physical information handling systems; and
instantiate the VM on the at least one physical information handling system of the plurality of physical information handling systems.

16. The computer-readable non-transitory memory medium of claim 15,
wherein, to receive the request, the instructions further cause the information handling system to receive, via the network, the request from a computer system; and
wherein, to provide the data structure and the digital signature associated with the data structure, the instructions further cause the information handling system to provide, via the network, the data structure and the digital signature associated with the data structure to the computer system.

17. The computer-readable non-transitory memory medium of claim 15, wherein the data structure includes a JavaScript Object Notation (JSON) object.

18. The computer-readable non-transitory memory medium of claim 15, wherein the one or more physical hardware components of the possible physical information handling system includes at least one physical hardware component that is compliant with a Federal Information Processing Standard (FIPS).

19. The computer-readable non-transitory memory medium of claim 15, wherein the one or more physical hardware components of the possible physical information handling system includes at least one graphics processing unit.

20. The computer-readable non-transitory memory medium of claim 15, wherein, to query each physical information handling system of the plurality of physical information handling systems for the information associated with the plurality of physical hardware components of the physical information handling system, the instructions further cause the information handling system to query each baseboard management controller of each physical information handling system of the plurality of physical information handling systems for the information associated with the plurality of physical hardware components of the physical information handling system.
